(19) United States
(12) Patent Application Publication
(10) Pub. No.: US 2003/0184625 A1
(43) Pub. Date: Oct. 2, 2003

(54) Ink cartridge

(76) Inventors: Pui Kuong Lui, Kowloon (HK); Yiu Cheong Law, Kowloon (HK)

Correspondence Address: ROSENBERG, KLEIN & LEE, 3458 ELLICOTT CENTER DRIVE-SUITE 101, ELLICOTT CITY, MD, 21043, US

(21) Appl. No.: 10/112,734

(22) Filed: Apr. 2, 2002

(51) Int. Cl. B41J 2/175

(52) U.S. Cl. 347/86

(57) ABSTRACT

An ink cartridge includes an ink tank body, a cover body sealed on the ink tank body and a ventilated member. The cover body has an ink-charging inlet, a fastened recess, an air inlet port formed by an upper opening adjacent to the fastened recess and a lower opening, and a sealing member being disposed underneath the cover body. Further, the ventilated member has a fastened portion for correspondingly fastening into said fastened recess and a piercing portion connected to the fastened portion, and the piercing portion is formed therethrough with at least one air channel extending along an axial direction. Whereby the piercing portion is for piercing said sealing member to make said air inlet port be opened to an ambient atmosphere that enters to an interior of the ink tank body through the air channel of the piercing portion.

### BACKGROUND OF THE INVENTION

1. Field of the Invention

The present invention is directed toward the art of ink cartridges and, more particularly, to an improved ventilation structure of an ink cartridge cover for such ink cartridges.

2. The Prior Art

Please refer to FIGS. 1 and 2, an ink cartridge 1a for a print head of an ink jet printer, which has an ink tank body 2a, a porous ink storage body being positioned in the ink tank body 2a, and a cover body 3a having an ink-charging inlet 30a and an air inlet port 31a formed to be continuous with one end of a meandering air groove 32a formed in a top surface of the cover body 3a for reducing evaporation losses due to ink. Further, the cover body 3a has a foil 33a (or an air inlet passage-sealing film) affixed on the top surface thereof by thermo-compression bonding, or else, for being sealed on the air inlet port 31a and the air groove 32a of the cover body 3a. The foil 33a has a tear line 330a thereon so as to define an affixed portion 331a and a tore portion 332a, wherein the tore portion 332a could be tore along the tear line 330a, so that the other end of the air groove 32a is appeared out to the atmosphere. Thus, air is supplied into the ink tank body 2a through the air groove 32a and the air inlet port 31a in an amount corresponding to an amount of the ink supplied to the print head from the ink cartridge 1a.

In this kind of conventional ink cartridge, for the ventilation, the ink cartridge 1a must tear off the foil 33a so as to make the ink be delivered into the print head. However, the foil 33a is affixed on the top surface of the cover body 3a hence it is easy to the foil 33a to be made a break by no carefulness (i.e. the air groove 32a is appeared out before the ink cartridge 1a is used in the ink jet printer), thereby to cause the air groove 32a to be communicated with the ambient atmosphere in this state.

### SUMMARY OF THE INVENTION

It is an object of the present invention to provide an ink cartridge for a printer, which is able to prevent the atmosphere from being communicated in the ventilation structure due to no carefulness before the ink cartridge is used in the printer.

In accordance with one aspect of the present invention, the ink cartridge comprises an ink tank body for containing ink, a cover body being tightly sealed on the ink tank body and a ventilated member. Wherein the cover body has an ink-charging inlet, a fastened recess, an air inlet port formed by an upper opening adjacent to the fastened recess and a lower opening being communicated to the upper opening thereof, and a sealing member being disposed underneath the cover body for sealing said lower opening of the air inlet port. Further, the ventilated member has a fastened portion for correspondingly fastening into said fastened recess and a piercing portion connected to the fastened portion, and the piercing portion is formed therethrough with at least one air channel extending along an axial direction. Whereby the piercing portion is for piercing said sealing member to make said air inlet port be opened to an ambient atmosphere that enters to an interior of the ink tank body through the air channel of the piercing portion.

Still other advantages and benefits of the invention will become apparent to those skilled in the art upon a reading and understanding of the following detailed description.

### BRIEF DESCRIPTION OF THE DRAWINGS

The invention may take physical form in certain parts and arrangement of parts, a preferred embodiment and method of which will be described in detail in this specification and illustrated in the accompanying drawings that form a part hereof, and wherein:

FIG. 1 is a perspective view of the ink cartridge due to the prior art.

FIG. 2 is a top view of the ink cartridge cover due to the prior art.

FIG. 3 is a perspective view of the ink cartridge due to the present invention.

FIG. 4 is a top view of the ink cartridge cover due to the present invention.

FIG. 5 is a cross-sectional view of the ink cartridge cover due to the present invention.

FIG. 5A is a cross-sectional view of another embodiment due to the present invention.

FIG. 6 is a perspective view of the ventilated member due to the present invention.

FIG. 7 is a top view of the ventilated member due to the present invention.

FIG. 8 is a cross-sectional view of the ventilated member due to the present invention.

FIGS. 9 and 10 are cross-sectional views schematically showing a sequence of operations for mounting the ink cartridge due to the present invention.

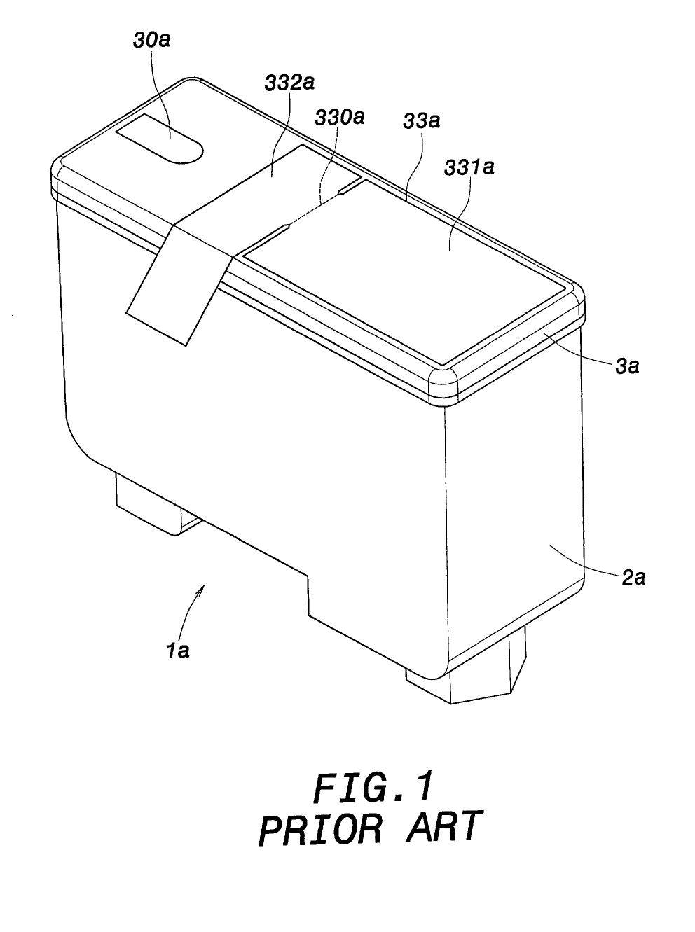

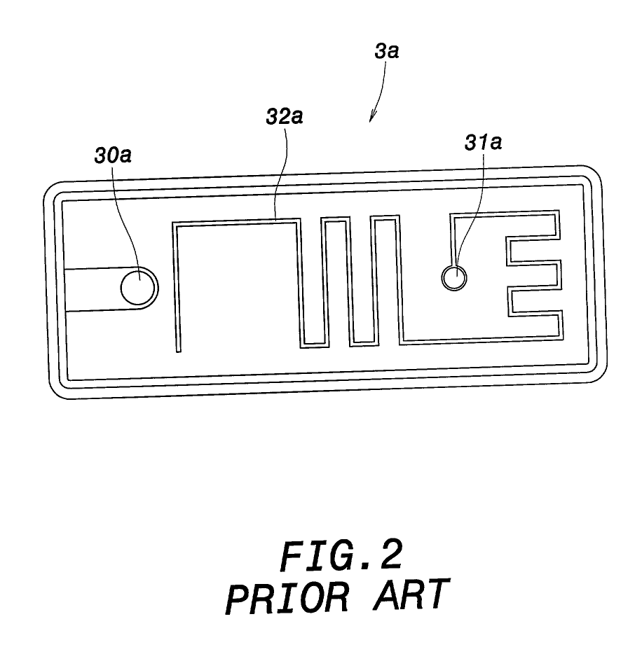

### DETAILED DESCRIPTION OF THE PREFERRED EMBODIMENT

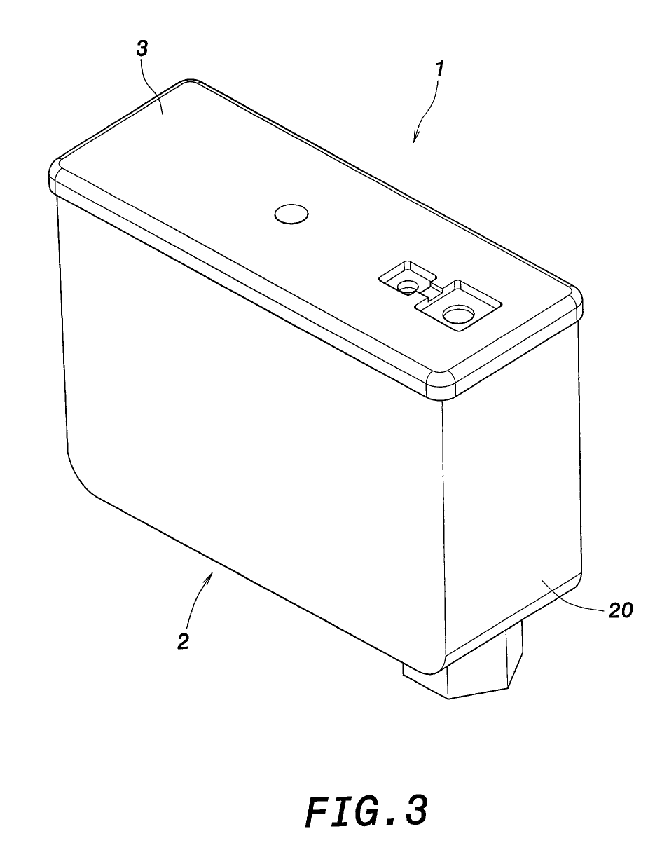

Referring now to the drawings wherein the showings are for the purposes of illustrating the preferred embodiment of the invention only and not for purposes of limiting same, the ink cartridge 1 of the preferred embodiment shown in FIG. 3, which comprises an ink tank body 2 having four lateral walls 20 whose free ends on which a cover body 3 has four edges respectively sealed, such as by being fastened thereto. The ink tank body 2 contains a porous body, e.g., of foamed synthetic material such as polyethylene, which is for storing ink in a state absorption.

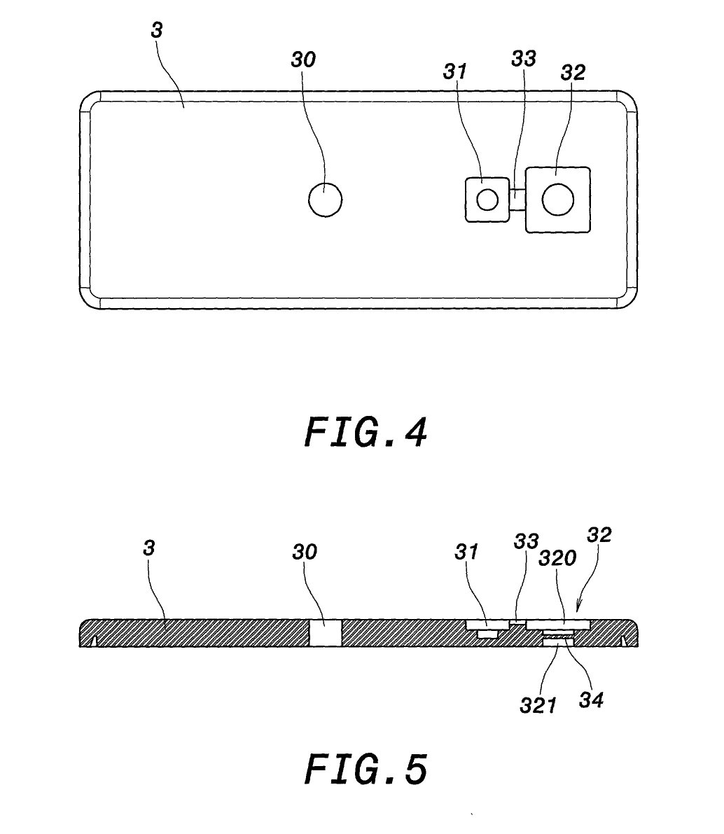

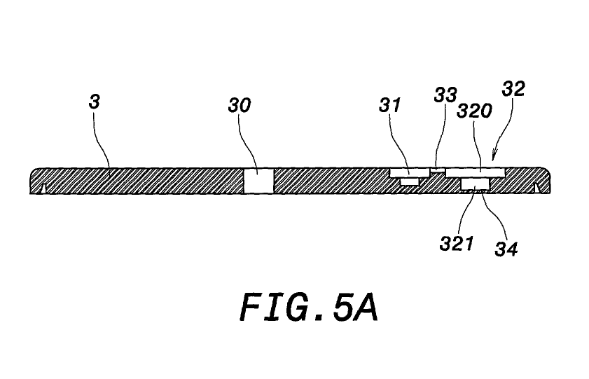

Referring to FIGS. 4, 5 and 5A, the cover body 3 has an ink-charging inlet 30, a fastened recess 31 and an air inlet port 32 adjacent to the fastened recess 31, wherein the ink-charging inlet 30 and the air inlet port 32 are for filling the porous body with the ink before shipment and for admitting air into a recessed space of the ink tank body 2 during use of the ink cartridge 1 in a print head of an ink jet printer, respectively. Further, the air inlet port 32 is formed by an upper opening 320 communicated to the fastened recess 31 by a connected groove 33 and a lower opening 321 being communicated to the upper opening 320, and a sealing member 34 being disposed underneath the cover body 3 for sealing said lower opening 321 of the air inlet port 32, rather than sealed onto a top of the cover body 3, thereby to be able to prevent the atmosphere from being communicated in the ventilation structure due to no carefulness before the ink cartridge 1 is used in the printer.

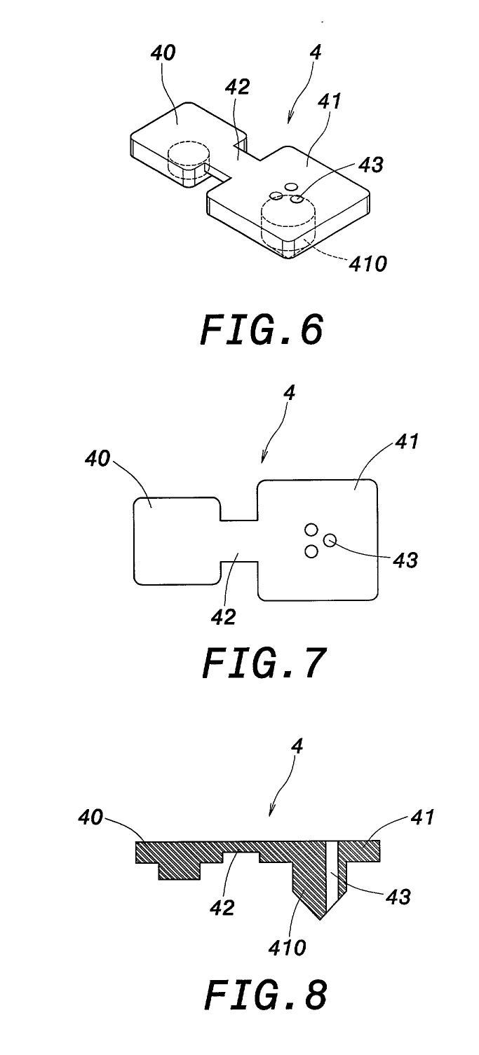

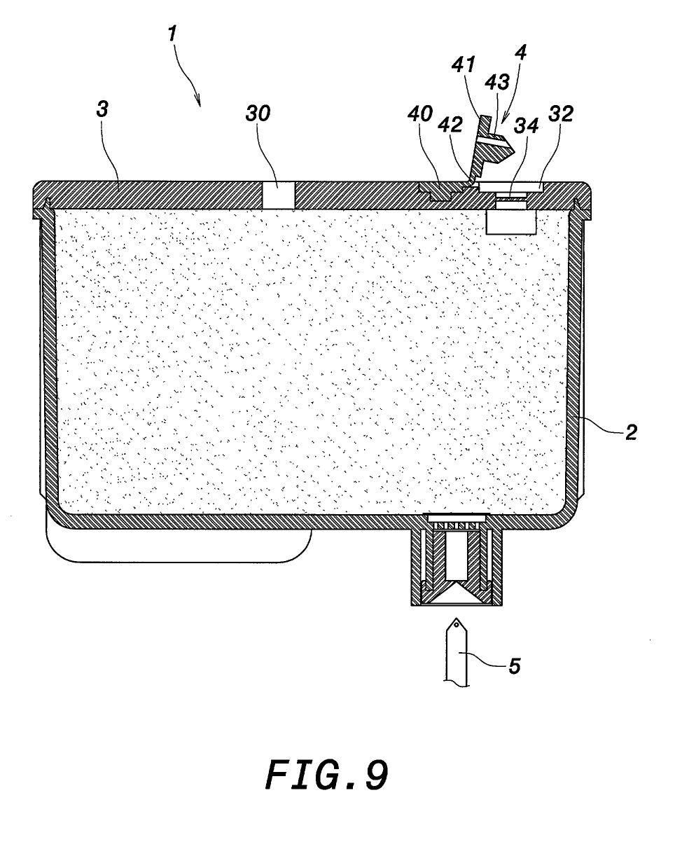

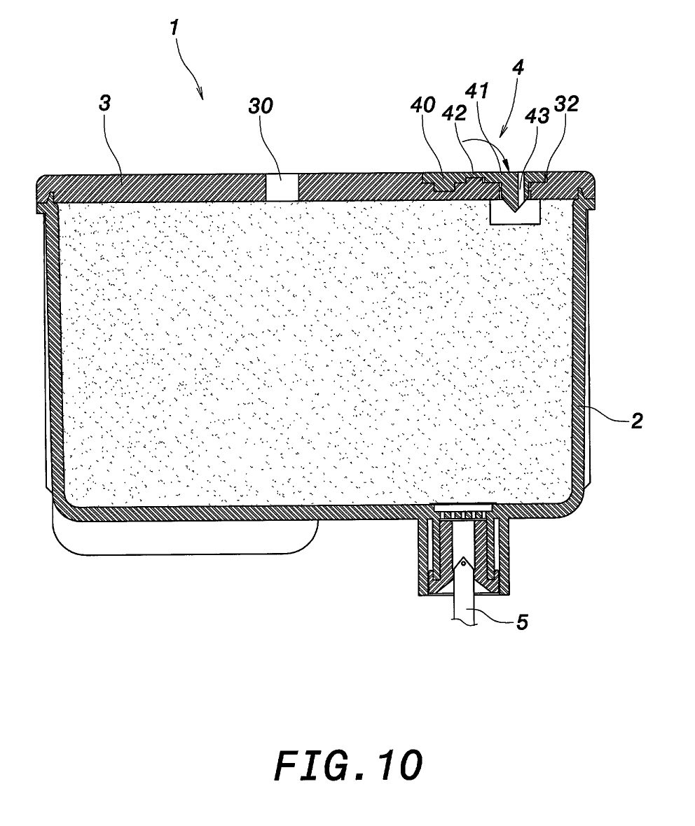

Referring to FIGS. 6 to 8, for the ventilation structure, the ink cartridge 1 further comprises a ventilated member 4 having a fastened portion 40 for correspondingly fastening into said fastened recess 31 of the cover body 3 as a fulcrum to support against the cover body 3 and a piercing portion 41 having an end connected to the fastened portion 40 by a connected portion 42. Further, the piercing portion 41 is formed therethrough with at least one air channel 43 (as three air channels in FIG. 6) extending along an axial direction, and the piercing portion 41 has a top surface at a predetermined angle relative to a top surface of the fastened portion 40, and the predetermined angle is 100-150 degrees before piercing through the sealing member 34 of the cover body 3 (see FIG. 9), then the predetermined angle is 180 degrees after piercing through the sealing member 34 of the cover body 3, so that the top surface of the piercing portion 41 is at the same level with the top surface of the fastened portion 40 (see FIG. 10). Additionally, the piercing portion 41, the fastened portion 40 and the connected portion 42 are substantially matched with the air inlet port 32, the fastened recess 31 and the connected groove 33 in a peripheral contour, respectively, and the piercing portion 41 has a tip 410 for easily piercing through said sealing member 34 of the cover body 3.

When the piercing portion 41 of the ventilated member 4 is moved in the closing direction to push inward the air inlet port 32 of the cover body 3 provisionally installed on the ink tank body 2 (the ink tank body 2 is mounted provisionally in the print head 5 of the ink jet printer) as shown in FIGS. 9-10, so that the tip 410 of the piercing portion 41 can be pierced to a portion of the sealing member 34 being disposed on the lower opening 321 of the air inlet port 32, so as to make the air inlet port 32 be opened to an ambient atmosphere that enters to an interior of the ink tank body 2 through at least one air channel 43 of the piercing portion 41. Therefore, an improved ventilation structure of the ink cartridge could be achieved.

Those skilled in the art will readily observe that numerous modification and alterations of the device may be made while retaining the teachings of the invention. Accordingly, the above disclosure should be construed as limited only by the metes and bounds of the appended claims.

What is claimed is:

1. An ink cartridge, comprising:
an ink tank body for containing ink;
a cover body being sealed on the ink tank body, the cover body having an ink-charging inlet, a fastened recess, an air inlet port formed by an upper opening adjacent to the fastened recess and a lower opening being communicated to the upper opening thereof, and a sealing member being disposed underneath the cover body for sealing said lower opening of the air inlet port; and
a ventilated member having a fastened portion for correspondingly fastening in said fastened recess and a piercing portion connected to the fastened portion, and the piercing portion formed therethrough with at least one air channel extending along an axial direction;
whereby the piercing portion is for piercing said sealing member to make said air inlet port be opened to an ambient atmosphere that enters to an interior of the ink tank body through at least one air channel of the piercing portion.

2. The ink cartridge as claimed in claim 1, wherein the piercing portion is connected to the fastened portion by a connected portion at an end thereof and the air inlet port is communicated to the fastened recess by a connected groove.

3. The ink cartridge as claimed in claim 1, wherein the piercing portion has a top surface at a predetermined angle relative to a top surface of the fastened portion before piercing through the sealing member of the cover body.

4. The ink cartridge as claimed in claim 3, wherein the predetermined angle is 100-150 degrees.

5. The ink cartridge as claimed in claim 1, wherein the air inlet port is communicated to the fastened recess by a connected groove.

6. The ink cartridge as claimed in claim 2, wherein the piercing portion, the fastened portion and the connected portion are substantially matched with the air inlet port, the fastened recess and the connected groove, respectively.

7. The ink cartridge as claimed in claim 1, wherein the piercing portion has a tip for piercing said sealing member.
